(19) United States
(12) Patent Application Publication
(10) Pub. No.: US 2023/0048471 A1
(43) Pub. Date: Feb. 16, 2023

(54) Unit Consisting of a Frame and an Image

(71) Applicant: Funky Frames SA, Genève (CH)

(72) Inventors: Talia Bally, Chêne-Bougeries (CH); David Bally, Chêne-Bougeries (CH)

(21) Appl. No.: 17/783,659

(22) PCT Filed: Jan. 11, 2021
(86) PCT No.: PCT/IB2021/050154

§ 371 Date: Jun. 9, 2022

(30) Foreign Application Priority Data
Jan. 15, 2020 (IB) PCT/IB2020/050287

(51) Int. Cl. G09F 1/12; G09F 1/08; G09F 13/04; G09F 15/00; G09F 7/10; A47G 1/06

(52) U.S. Cl. CPC G09F 1/12; G09F 1/08; G09F 13/0413; G09F 13/0445; G09F 15/0012; G09F 7/10; A47G 1/0616; G09F 2007/1843

(57) ABSTRACT

Unit consisting of the combination of a frame having at least one lateral slot and an image, the image being formed by—a first portion, referred to as the ‘intra-frame portion’, with a surface that is same as or smaller than the surface defined by the frame, and by—at least one second portion, referred to as the ‘extra-frame’ portion, forming an extension of the first portion that emerges out of the frame, the image being designed to be removably inserted into the frame through the slot in such a way that the intra-frame portion is arranged in an area defined by the frame and the extra-frame portion is arranged in an area outside the frame.

### FIELD OF THE INVENTION

The invention relates to pictures contained in a frame. It relates more specifically to pictures of which at least a part is disposed outside the frame.

### PRIOR ART Objects as defined in the preceding chapter are disclosed in patent BE 818 068 and patent application WO 2019/180535.

Although it is possible to change the picture while keeping the same frame, this type of operation is not easy. With a frame as disclosed in BE 818 068, the picture has to be detached, most often unstuck, from the frame, thus making the operation tricky.

With a frame described in WO 2019/180535, any change of picture also requires the picture extension support to be changed.

There is therefore a need to remedy the aforementioned drawbacks, by offering a means for easily changing the picture while keeping the same frame.

### GENERAL DESCRIPTION OF THE INVENTION

An aim of the present invention is to make it easier to replace a picture of which at least a part is disposed outside the zone delimited by the frame of the picture.

Another aim is to produce frames of relatively small dimensions.

To this end, the invention relates to an assembly made up of the combination of a frame provided with at least one slot and a picture, said picture being formed of a first part, called the “intra-frame part” with an area equal to or smaller than the area delimited by the frame and at least one second part, called the “extra-frame part”, forming an extension of the first part that emerges outside the frame, the picture being suitable for being removably introduced into the frame, through the slot, such that the intra-frame part is disposed in a zone delimited by the frame and such that the extra-frame part is disposed in a zone disposed outside the frame.

The slot is preferably disposed along the upper edge of the frame. “Upper edge” is understood to mean the upper side of the frame when the latter is oriented vertically.

The frame according to the invention may have a plurality of slots disposed along a plurality of edges of the frame, and this offers the advantage of using a greater variety of pictures, in particular those of which the out-of-frame part is directed toward a side or toward the bottom of the frame.

The picture according to the invention may have a plurality of out-of-frame parts. In this case, these extensions are preferably situated on the same side of the frame. An example of this embodiment could be applied with a picture showing a plurality of mountains. In this case, each summit would form an out-of-frame part of the picture.

These extensions may also be disposed on each lateral side of the frame, on the left and on the right. This configuration is obviously possible only if each side of the frame has a slot.

A downward picture extension is also possible, but in this case, the frame has to have a mechanism for holding the picture, so as to prevent the latter from accidentally falling. The holding mechanism may simply consist of inducing sufficiently large frictional forces between the frame and the picture, such that the latter cannot slide downward.

The insertion or withdrawal of a picture can be made easier by associating with each slot picture guiding elements, for example rails, which are arranged on the inner side of the frame, perpendicular to the direction of the slot.

### DETAILED DESCRIPTION OF THE INVENTION

The invention is explained in greater detail using an example illustrated by the following figures:

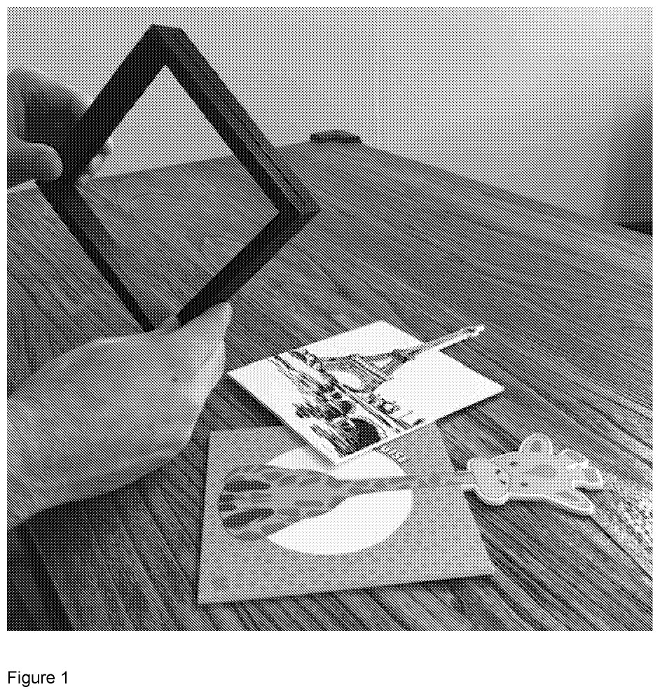

FIG. 1 shows an assembly according to the invention, comprising a frame and two pictures, prior to the insertion of a picture.

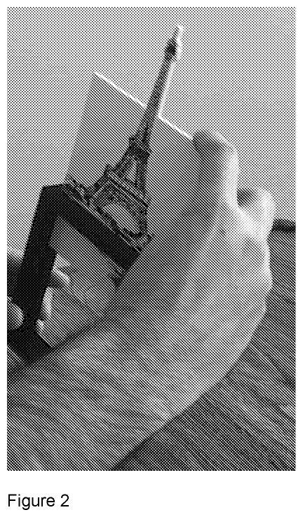

FIG. 2 shows the insertion of a picture into the frame.

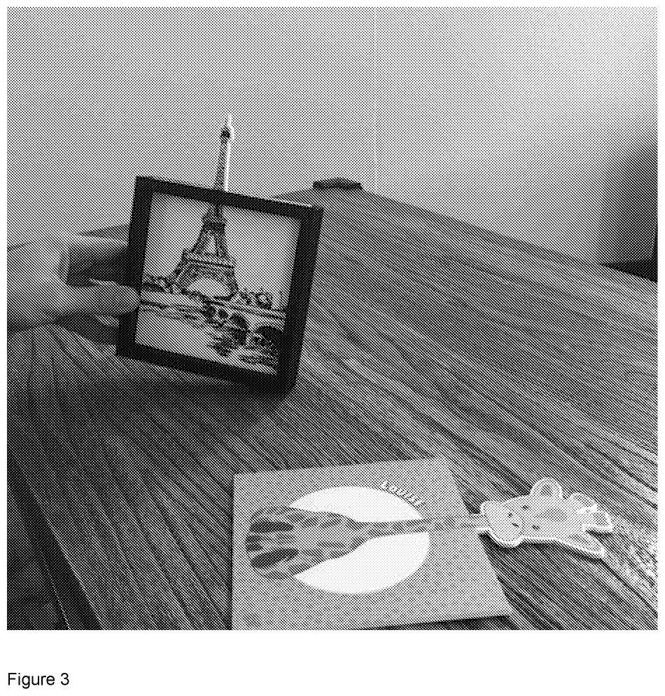

FIG. 3 shows a front view of the picture in FIG. 2, when it is fully inserted into the frame.

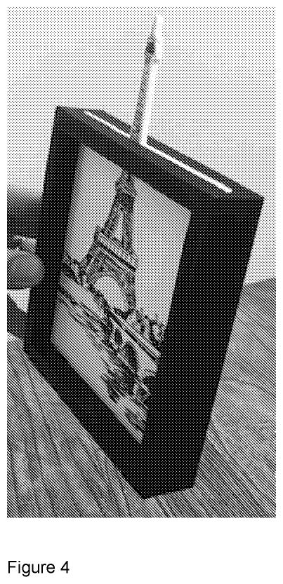

FIG. 4 shows a perspective view of the frame and picture in FIG. 3.

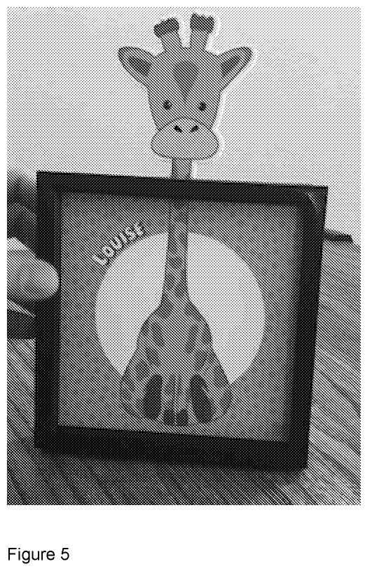

FIG. 5 shows the frame in the preceding figures but containing another picture.

In this example (see FIG. 1), the frame forms a square. It comprises a slot disposed along its upper edge. Each picture (Eiffel Tower or giraffe) is formed of an intra-frame part, the area of which is substantially equal to the area delimited by the frame. In the example shown, the intra-frame part also has a square shape, the surface of which occupies the entire inner surface of the frame. This equivalence of areas is however not necessary. The surface of the intra-frame part can be considerably smaller than the inner surface of the frame.

Likewise, the intra-frame part does not necessarily have the same geometric shape as the inner surface of the frame. If the latter forms a square, as in the example illustrated, the intra-frame part of the picture can for example be triangular. In this case, the base of the triangle rests on the lower edge of the frame.

The insertion of a picture (see FIG. 2) is realized through the slot.

Once the picture has been inserted (cf. FIGS. 3 and 4), the picture is held firmly inside the frame. In the example illustrated, the picture cannot move laterally inside the frame since its width is substantially equivalent to the width of the frame.

When it is desired to replace the picture, the frame can be turned over so that the slot is disposed downward, and this makes it easier to withdraw the picture, by virtue of the force of gravity.

In addition or alternatively, a tensile force is exerted on the out-of-frame part of the picture. The insertion of a new picture (see FIG. 6) is realized in the same way as for the preceding picture.

It goes without saying that the invention is not limited to the aforementioned examples.

Although this invention can be advantageously used with frames of small dimensions, for example 10 cm×15 cm, it can also relate to objects with considerably larger dimensions, of the order of a meter, or even greater.

The invention is also not limited to frames in the shape of a quadrilateral. It relates to frames of any shape, for example of regular polygon (triangle, hexagon or rhombus) or irregular polygon shape.

Any material suitable for the intended use may be used.

Finally, although the area of the out-of-frame part of the picture is preferably smaller than the intra-frame area, an inverse configuration is also possible.

1-6. (canceled)

7. A picture frame assembly comprising:
a frame including a plurality of side edges and a picture display area, one of the plurality of side edges including a slot; and
a picture including an intra-frame part and an extra-frame part,
wherein an area of the intra-frame part is equal or smaller than the picture display area,
wherein the extra-frame part forms an extension of the intra-frame part and is configured to emerge from the frame via the slot, and
wherein the slot and the picture are configured such that the picture can be removably inserted into the frame via the slot, such that the intra-frame part of the picture is disposed at the picture display area of the frame, and the extra-frame part of the picture is disposed outside of the frame.

8. The picture frame assembly of claim 7, wherein another one of the plurality of side edges includes another slot.

9. The picture frame assembly of claim 7, wherein the frame includes a pair of picture guides arranged within the frame and extending in an axis that is perpendicular to an axis of extension of the slot.

10. The picture frame assembly of claim 7, wherein the intra-frame part of the picture has a rectangular or square shape.

11. The picture frame assembly of claim 7, wherein the extra-frame part of the picture has an irregular shape.

12. The picture frame assembly of claim 7, wherein the frame includes a pair of picture guides arranged within the frame and extending in an axis that is perpendicular to an axis of extension of the slot,
wherein the intra-frame part of the picture has a rectangular or square shape, wherein the pair of picture guides are spaced apart to slidably accommodate the rectangular or square shaped intra-frame part via the slot.

13. The picture frame assembly of claim 10, wherein the picture includes an image that partially covers a surface area of the rectangular or square shaped intra-frame part, and the image extends into the extra-frame part.

14. The picture frame assembly of claim 13, wherein a shape of the extra-frame part is defined by a part of the image on the extra-frame part.
